(19) United States
(12) Patent Application Publication
(10) Pub. No.: US 2011/0271236 A1
(43) Pub. Date: Nov. 3, 2011

(54) DISPLAYING CONTENT ON A DISPLAY DEVICE

(75) Inventor: Vikas JAIN, BANGALORE (IN)

(73) Assignee: KONINKLIJKE PHILIPS ELECTRONICS N.V., EINDHOVEN (NL)

(21) Appl. No.: 13/093,875

(22) Filed: Apr. 26, 2011

(30) Foreign Application Priority Data
Apr. 29, 2010 (EP) 10161392.5

(51) Int. Cl. G06F 3/048

(52) U.S. Cl. 715/863

(57) ABSTRACT

A method (100) for displaying content on a display device based on gesture input is disclosed. The method comprises receiving the gesture input (102) associated with the content to be viewed as a i) free form gesture or as a ii) gesture definition, determining whether the received gesture input is in the form of a free form gesture and if so interpreting the received gesture (104) using a gesture interpretation mechanism and obtaining a gesture definition, generating content views (106) based on the gesture definition, the content views defining the arrangement and presentation of the content to a user for viewing, and displaying (108) the generated content views on the display device. The disclosed method is useful for content management devices such as television, set top boxes, Blu-ray players, handheld devices and mobile phones. The disclosed method is also useful for personal computers in desktop management and thumbnail view management.

### FIELD OF THE INVENTION

The present invention relates to the field of displaying content on a display device and more specifically to the field of displaying content on a display device based on gesture inputs.

### BACKGROUND OF THE INVENTION

The use of gestures to perform certain operations on the displayed UI elements is disclosed in US2008/0168403. The disclosed method uses circle select gesture and shape gesture for i) performing grouping action on the displayed UI elements ii) creating a graphic image of a particular shape and iii) selecting or moving the displayed UI elements. The disclosed method is limited to use of gestures on the displayed UI elements.

### SUMMARY OF THE INVENTION

Accordingly, it is an object of the present invention to use gestures for performing certain operations on content that is going to be displayed. The present invention is defined by the independent claims. The dependent claims define advantageous embodiments.

The object of the present invention is realized by providing a method for displaying content on a display device based on gesture input, the method comprising:
receiving the gesture input associated with the content to be viewed as a i) free form gesture or as a ii) gesture definition
determining whether the received gesture input is a free form gesture and if so interpreting the received gesture using a gesture interpretation mechanism and obtaining a gesture definition;
generating content views based on the gesture definition, the content views defining the arrangement and presentation of the content to a user for viewing; and
displaying the generated content views on the display device.

Content views could be in the form of at least one of i) list view ii) detailed list view iii) thumbnail view iv) icons view v) mixed content view comprising list view and thumbnail view.

The word content view here refers to the manner in which the content is to be arranged and presented to the user for viewing. As an illustration of a simple use case, the user input could be a free form line gesture associated with the content. A line gesture definition could be obtained using a gesture interpretation mechanism. The content (e.g., photos) could be arranged in a linear fashion (e.g., arranging the thumb nail of photos in a straight line) and presented to the user for viewing.

Users have opportunities to enjoy the content the way they want. This is due to the advent of connectivity within home environment and Internet support within consumer devices. At the same time the content views are limited to pre-defined views (e.g. made available by the consumer device manufactures).

As an illustrative example, personal computers offer limited capabilities on arranging files and media files. As a further example, the items on the desktop can be arranged by selecting the option arrange icons by i) name ii) size iii) type iv) modified v) auto arrange vi) align to grid. As a furthermore illustrative example, the windows explorer supports limited content views such as i) thumbnails ii) tiles iii) icons iv) list iv) details.

Consumer devices generally have similar limited capabilities on offering the content views typically being list(s) view, tree view and thumbnail views to name a few.

The disclosed method allows the user to display the content in a flexible and intuitive manner with the support of gesturing as an input mechanism (e.g. on consumer devices such as television). This could allow the user to experiment with content management that includes generation of content views and rendering of the content. This could make content viewing interactive resulting in an engaged user experience.

The disclosed method offers the flexibility to display the content in an intuitive way. Further, the content views could be designed around users thereby enhancing the user experience and the Net Promoter Score (NPS).

The disclosed method while defining new content views could keep the content navigation principles unaltered so that the user is not confused. This could reduce compatibility related problems and enhance user experience.

Further, the disclosed method could employ the free form gesture or the gesture definition provided by the user. This gives flexibility to the user to suitably display the content based on his needs.

In an embodiment, the method comprises
selecting the free form gesture input from a list of pre-determined gestures; and
associating the selected gesture with the content to be viewed.

A resource constrained display device could have a well defined list of gestures that could be made available to the user (e.g. line, rectangle, arc, circle, alphabets, numerals) thereby optimizing the processing power needed to generate the content views associated with the gesture.

In a further embodiment, the method comprises
selecting the gesture definition from a list of pre-determined gesture definitions; and
associating the selected gesture definition with the content to be viewed.

This embodiment has the advantage that the user need not have to create gesture while associating content with gesture. The user could rather select a gesture from the gesture definition list and associate it with the content. Hence, association of a gesture with the content can happen at any point of time. Further, the user is allowed to modify gesture definition list. In a still further embodiment, the free form gesture input associated with the content to be viewed is in the form of at least one of:
a line and the content view is generated in a linear mode based on the obtained line gesture definition
a rectangle and the content view is generated in a rectangular mode based on the obtained rectangular gesture definition
a Z shape and the content view is generated in a zig-zag mode based on the obtained Z gesture definition
an arc or circle and the content view is generated in an arc/circular mode based on the obtained arc/circular gesture definition
an alphabet and the content view is generated in an alphabetic mode based on the obtained alphabetic gesture definition
a numeral and the content view is generated in a numeric mode based on the obtained numeric gesture definition.

This embodiment provides the user a range of pre-defined gestures that are simple (e.g., line, rectangle, arc) to more complicated (Z shape, alphanumeric) but still are intuitive and personalized for the user. Alphabets and numerals could also be used as gesture definitions and the content views could be generated based on alphanumeric gestures.

In a still further embodiment, the gesture definition associated with the content to be viewed is in the form of at least one of:
a line and the content view is generated in a linear mode based on the selected line gesture definition
a rectangle and the content view is generated in a rectangular mode based on the selected rectangular gesture definition
a Z shape and the content view is generated in a zig-zag mode based on the selected Z gesture definition
an arc or circle and the content view is generated in an arc/circular mode based on the selected arc/circular gesture definition
an alphabet and the content view is generated in an alphabetic mode based on the selected alphabetic gesture definition
a numeral and the content view is generated in a numeric mode based on the selected numeric gesture definition.

This embodiment has the advantage that the users can visualize the content in most common shapes like line, arc, zig-zag line and circle but restrict themselves to device provider defined content views. Further, content views could be personalized with the user's initials or important dates that could be represented by alphabets and numerals. Hence, predetermined gesture list could already contain the gesture definition for the same.

In a still further embodiment, the method further comprises
creating hand gesture; and
associating the hand created gesture with the content to be viewed.

This embodiment provides flexibility to the user to generate personalized and intuitive content views. As an illustrative example, a gesture based on initials of a user (e.g., Character “D” for David; Character “P” for Peter) wherein the content (e.g., photos) is arranged in the manner of the character “D” or in the manner of the character “P” could be more enjoyable to the user. This could enhance user experience. The word hand created gesture here refers to gestures created either by hand or by using stylus or keyboards or track balls or touch pads or joy sticks and the like.

In a still further embodiment, the method further comprises
comparing the obtained gesture definition with the list of pre-determined gesture definitions and obtaining a closely matched gesture definition, the closely matched gesture definition corresponding to the hand created gesture;
generating the content views based on the closely matched gesture definition, the content views defining the arrangement and presentation of the content to the user for viewing; and
displaying the generated content views on the display device.

This embodiment allows the user to create complex gestures that are intuitive and associate it with the content to be viewed. Further, this embodiment allows the user to generate personalized and intuitive content views based on the complex gestures hand drawn by the user. A resource constrained display device could have a well defined list of gesture definitions (e.g. line, rectangle, arc, circle, alphabet and numeral) and any user created gesture definition could be matched to obtain the closely matched gesture definition. This could reduce the memory required to maintain the complete list of gesture definitions and also optimize the processing power needed to render the content views associated with the gesture.

Alternately, the free form gesture could be compared with the list of pre-determined gestures and a closely matched gesture and the corresponding gesture definition could be obtained.

In a still further embodiment, the method further comprises
adding/deleting gestures from/to the list of pre-determined gestures.

This embodiment provides flexibility to the user to add/delete a gesture and continue maintaining a well defined list of gestures. This could provide more flexibility to the user to define content views of his/her choice as more and more gestures become available to the user. Further, this embodiment could also overcome the limitation of a display device that has limited pre-defined list of gestures. As an illustrative example, let us assume that the pre-defined list of gestures supported includes a horizontal line and a vertical line. The user creates a new gesture that is a diagonal line that does not exist in the pre-defined list of gestures. In such a scenario, the user can add the new diagonal line gesture to the pre-defined list of gestures.

In a still further embodiment, the method further comprises
adding/deleting gesture definitions from/to the list of pre-determined gesture definitions.

This embodiment provides flexibility to the user to add/delete a gesture definition and continue maintaining a well defined list of gesture definitions. This could provide more flexibility to the user to define content views of his/her choice as more and more gesture definitions become available to the user. Further, this embodiment could also overcome the limitation of a display device that has limited pre-defined list of gesture definitions. As an illustrative example, let us assume that the pre-defined list of gesture definitions supported includes a horizontal line and a vertical line. A new gesture definition e.g. diagonal line that does not exist in the pre-defined list of gesture definitions is created. In such a scenario, the user can add the new diagonal line gesture definition to the pre-defined list of gesture definitions.

In a still further embodiment, the method further comprises
determining transition effects to be used while rendering the content on the display device; and
rendering the content views based on i) the determined transition effects and ii) the gesture definition associated with the content.

This embodiment allows personalization of content views. The transition effects could be determined based on i) the total time duration available for the content to be rendered ii) the number of steps in which the content is to be rendered.

Once the user has determined a timeline for presentation of the content and has decided to render the content, it will be easy to generate the content views using the associated transition effects. As an exemplary illustration, transition effects such as fading and wipes could be realized. Further, transition effects could be used to fade the video in and out.

Let us consider an exemplary illustration wherein the content view of a photo of a user is to be rendered in N steps and the total time duration is T seconds. If N=7 and T=14 seconds, then t=(T/N)=(14/7)=2 seconds. This implies that the content will have to be rendered every 2 seconds in a transition mode. The transition could end at the end of 14 seconds and the complete content could be displayed.

The applied transition effect could vary in i) size of the content ii) transparency of the content over N steps wherein every step is executed at relative time t(n) with respect to the total time duration T such that

0<t(n)<T and

t(n−1)<t(n)<t(n+1)

where t(N−1)=T and t(0)=0.

The transparency of the content could be minimum at t=0 and maximum at t=(N−1).

N and T could be user defined. Alternately, there could be a default value per gesture definition. Duration between each step could be uniform or non-uniform depending on user's choice/settings. It is also possible that other features of content like brightness, hue, contrast could be varied over timeline and applied as transition effects while rendering the content.

Maximum and minimum transparency could be platform defined values. Further flexibility could be given to the user to override the pre-defined transparency values. The dimensions of the content scaling while rendering the content could be platform defined values. Further, flexibility could be given to the user to override the pre-defined values.

Furthermore, the transition effect could be applied based on the gesture definition. As an illustrative example, the thumb nail of photos could be arranged in a straight line based on a line gesture. Further, the photo could be rendered in a straight line mode using the selected transition effect.

The size of the photo and other parameters such as brightness, hue, saturation while rendering the photo at t=t₀, t=t₁, t=t₂ . . . could be controlled. This could enhance user experience and provide more flexibility to the user in generating personalized content views.

In a still further embodiment, the method further comprises
storing the determined transition effects and the gesture definition associated with the content to be viewed as settings; and
using the stored settings to generate the content views.

This has the advantage that the gesture definition need not be applied on the content immediately but could be stored as settings to be applied on the content at a later point of time. This could enable the user to have more flexibility in personalizing his/her content views.

In a still further embodiment, the user could relate the free form gesture or the gesture definition associated with the content to be viewed in at least one of the following manner:
Singular content level association
Plural content level association
Content type level association
Content viewing time level association

This embodiment allows further personalization of the content views. The user can associate the gesture definition with the content in multiple ways. This association of the gesture definition with the content could be applied for generating the content view as well as transition effects associated with rendering the content.

a) Singular content level association: The gesture definition could be associated to a particular content file (e.g., an image or a video) along with the transition effect that needs to be applied on the content while rendering the content file.

b) Plural content level association: The gesture definition could be associated with a content directory along with the transition effect that needs to be applied on the content directory. In such a scenario, all the contents (and the sub-directories) within that directory could use the associated gesture definition for generating the content view. Further, the content could be rendered based on the applied transition effect.

c) Content type level association: The gesture definition could be associated to a particular type of content. A user for e.g., could decide to associate a line gesture for all images while use circle gesture for all videos thereby associating different gestures for different content types. This could be extended to mime-types associated with different content types. This could be relevant when content is being retrieved from Internet or via other connectivity interfaces like DLNA/UPnP. It could be possible to associate the gesture with a specific meta-data of the content e.g., all files created by a user could use one gesture while all files created by user's spouse could use another gesture for generating content views and transition effects for rendering the content.

d) Content viewing time level association: The gesture definition could be associated with the content (s) for a specific data/time (e.g., associating it on a birthday or anniversary) and/or for a specific duration (e.g., next 3 hours when the user is watching along with some friends/guests) and/or for specific slots within a day as per viewing pattern (e.g., in the morning to suit users favorite gesture while in the afternoon as per user wife's gesture definitions and in the evening as per users family favorite gesture).

There needs to be rules defined to prioritize the gesture definitions to be applied if multiple gesture definitions are eligible for the same content by virtue of various associations made by the user. One suggested way to prioritize the gesture definition to be applied could be to follow the below mentioned rule in the decreasing order

1. Content viewing time level association (time domain is given priority)

2. Singular content level association (local selection is given priority over global selection)

3. Plural content level association (A gesture applied over content sub-directory could have a higher priority over gesture applied over parent directory)

4. Content type level association

In a still further embodiment, the method further comprises
determining whether the display device on which the content views are to be generated is a non-gesture based display device and if so

a) importing gesture definitions;

b) generating the content views using i) the imported gesture definitions and ii) the received gesture definition associated with the content to be viewed; and

c) displaying the generated content views on the non-gesture based display device.

This embodiment extends the feature available in gesture based devices to non-gesture based devices. This has the advantage that the disclosed method is useful to devices that do not support gestures but still want to generate content views based on gestures. In such a scenario, the non-gesture based device could import the gesture definitions from other devices that support gesture definition and generate personalized content views to the user. This could enhance user experience and improve the Net Promoter Score.

Further, it is noted that other devices from where gesture definitions could be imported need not be a gesture based device as long as the other device is able to provide gesture definitions.

Alternately, it is also possible that a gesture based device having limited free form gestures/gesture definitions could import gestures/gesture definitions from yet another gesture based device. This could provide more choices and flexibility to the user to select free form gestures/gestures definitions and generate personalized content views.

Further, it is noted that it is also possible to import pre-defined free form gestures from a gesture based device into a non-gesture based device thereby allowing a user to generate personalized content views based on the imported pre-defined free form gestures.

The invention also provides an apparatus for displaying content on a display device based on gesture input, the apparatus comprising:
a gesture input unit configured to receive the gesture input associated with the content to be viewed as a i) free form gesture or as a ii) gesture definition
a logical determining unit configured to determine whether the received gesture input is a free gesture and if so interpreting the received free form gesture using a gesture interpretation mechanism and obtaining a gesture definition;
a content view generating unit configured
to generate content views based on the gesture definition, the content views defining the arrangement and presentation of the content to a user for viewing; and
to display the generated content views on the display device.

Further, the content view generating unit could be further configured to generate transition effects while rendering the content as disclosed in the embodiments.

The apparatus also comprises a software program comprising executable codes to carry out the above disclosed methods.

### BRIEF DESCRIPTION OF THE DRAWINGS

The above-mentioned aspects, features and advantages will be further described, by way of example only, with reference to the accompanying drawings, in which the same reference numerals indicate identical or similar parts, and in which:

FIG. 1 is an exemplary schematic flowchart illustrating the method for displaying content on a display device according to an embodiment of the present invention;

FIG. 2 schematically illustrates exemplary content views;

FIG. 3 is an exemplary schematic representation illustrating the navigation of the displayed content view according to an embodiment of the present invention;

FIG. 4 is an exemplary schematic representation illustrating few exemplary gesture definitions and associated content views generated;

FIG. 5 is an exemplary schematic representation illustrating a hand created gesture according to an embodiment of the present invention;

FIG. 6 is an exemplary schematic block diagram illustrating matching of the hand created gesture definition with the pre-defined gesture definition according to an embodiment of the present invention;

FIG. 7 is an exemplary schematic block diagram illustrating the addition/deletion of new gestures according to an embodiment of the present invention;

FIGS. 8A-8C show exemplary schematic representation illustrating the generation of content views using transition effects according to an embodiment of the present invention;

FIG. 9 is an exemplary schematic representation illustrating the ways of associating gestures with the content according to an embodiment of the present invention;

FIG. 10 is an exemplary schematic block diagram illustrating the modules to generate content views on a non-gesture based display device according to an embodiment of the present invention; and

FIG. 11 is a schematic block diagram of an apparatus for displaying content on a display device according to an embodiment of the present invention.

### DETAILED DESCRIPTION OF THE EMBODIMENTS

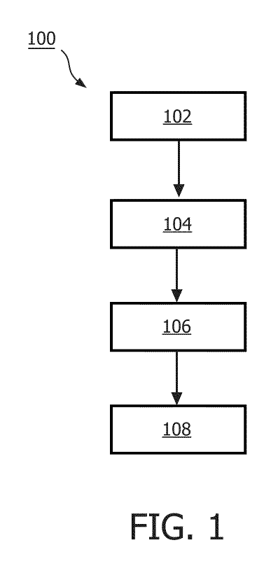

Referring now to FIG. 1, the method 100 for displaying content on a display device comprises a step 102 of receiving the gesture input associated with the content to be viewed as a i) free form gesture or as a ii) gesture definition. Free from gestures could be generated using a gesture input device. The gesture input mechanism could be a 2-D touch pad or a pointer device. Gesture input device could be a separate device from the rendering device like mouse or a pen or a joy stick. Alternately, it could be embedded within the rendering device like touch screen or a hand held device. Gesture input devices are generally used to generate a mark or a stroke to cause a command to execute. By way of example, the gesture input devices can include buttons, switches, keyboards, mice, track balls, touch pads, joy sticks, touch screens and the like. Gesture definition could be i) logic or a program representing mark or stroke ii) well defined interpretation of a gesture wherein size and other details of gesture are not considered important.

In step 104 it is determined whether the received gesture input is a free form gesture. If so, the received gesture is interpreted using a gesture interpretation mechanism and a gesture definition is obtained. There are gesture interpretation mechanisms available in the prior art. These known gesture interpretation mechanisms could be made use of. Methods for 2-D gesture interpretation could include bounding box, direction method, corner detection and radius of curvature.

Bounding box method could be appropriate for simple gestures. Direction method could be used to define large number of gesture definitions and easy to implement. This method may not be accurate and could be suitable for scenarios where there could be loss of resolution. Corner detection is more accurate but it could be difficult to support curves. Radius of curvature method is accurate and supports curves. This could require more processing power as compared to other methods.

In step 106 the content views are generated based on the gesture definition. The content views define the arrangement and presentation of the content to be made available to the user for viewing. In step 108 the generated content views are displayed on the display device. As an illustration of a simple use case, the user input could be a free form line gesture associated with the content. A line gesture definition could be obtained using a gesture interpretation mechanism. The content (e.g. photos) could be arranged in a linear fashion (e.g. arranging the thumb nail of photos in a straight line) and presented to the user for viewing.

In an embodiment, the method comprises selecting the gesture input from a list of pre-determined gestures and associating the selected gesture with the content to be viewed. Further, it is also possible to select the gesture definition from a list of pre-determined gesture definitions and associate the selected gesture definition with the content to be viewed.

A resource constrained display device could have a well defined list of gestures that could be made available to the user (e.g. line, rectangle, arc, circle, alphabets, numerals) thereby optimizing the processing power needed to generate the content views associated with the gesture.

As an illustrative example, the pre-defined gesture input could correspond to a line gesture, an arc/circular gesture, a rectangular gesture or a triangular gesture. The user could select the gesture that he/she intends to associate with the content. A gesture definition corresponding to the input gesture could be generated and associated with the content to be viewed. Alternately, instead of a gesture input, the user can select a gesture definition from a list of pre-determined gesture definitions and associate the selected gesture definition with the content to be viewed.

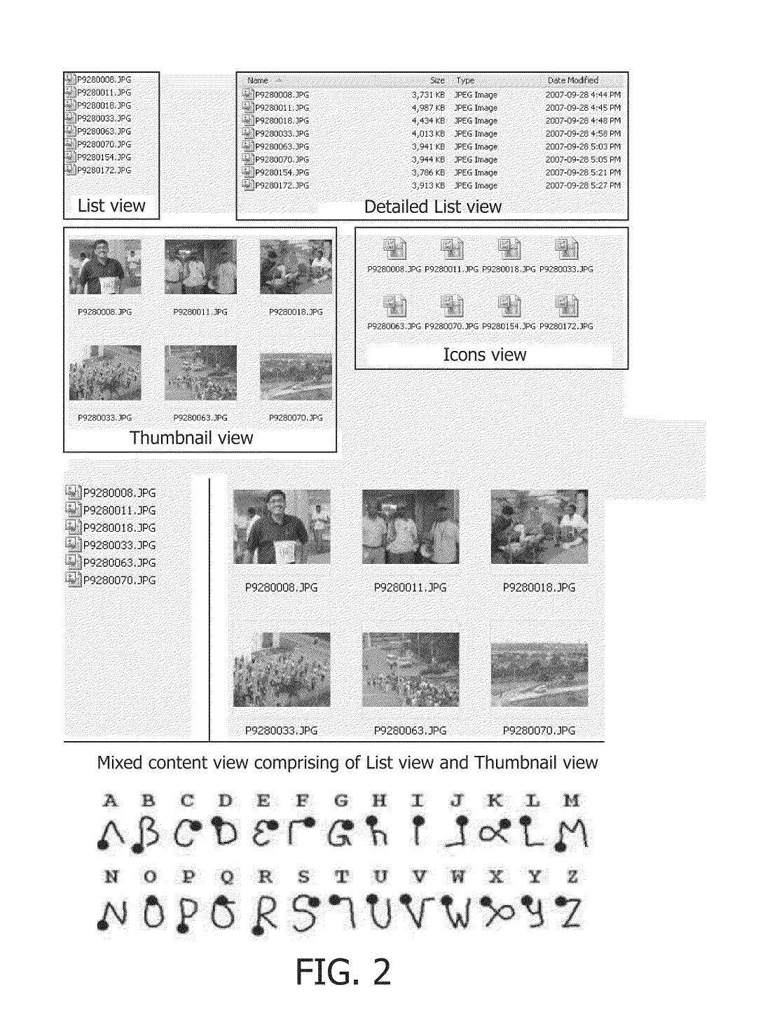

Referring now to FIG. 2, the content views could be in the form of at least one of i) list view ii) detailed list view iii) thumbnail view iv) icons view v) mixed content view comprising list view and thumbnail view. Further, although the figure illustrates content as photos, the content could be static in nature (e.g. option menus, settings menu, dialogs, wizards) or dynamic in nature (e.g. files, media content) depending upon how the content is created.

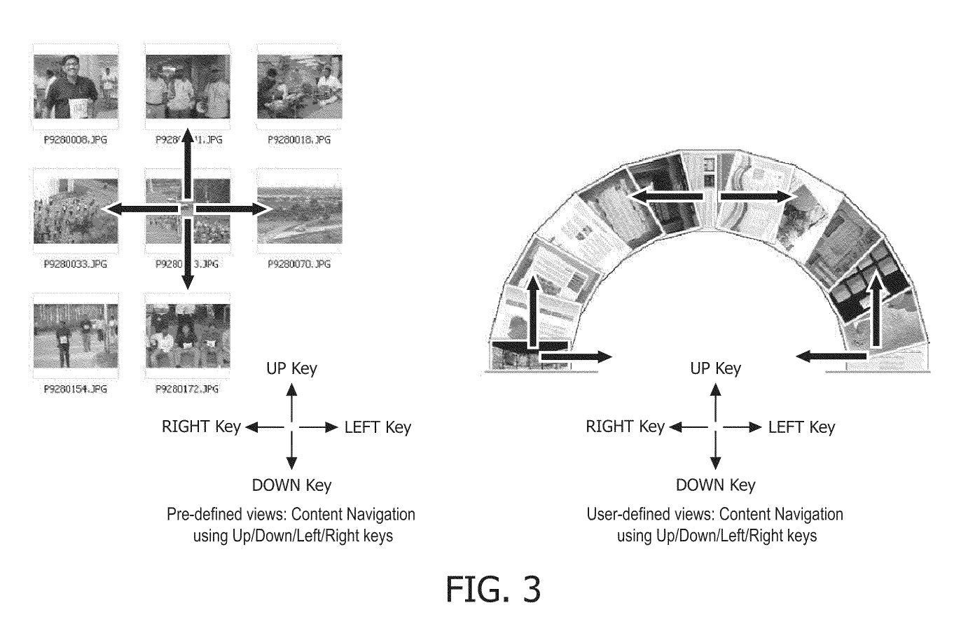

Referring now to FIG. 3, the disclosed method while defining new content views could keep the content navigation principles unaltered. This makes the navigation of the displayed content easy (i.e. user is not confused). This could reduce compatibility related problems and enhance user experience.

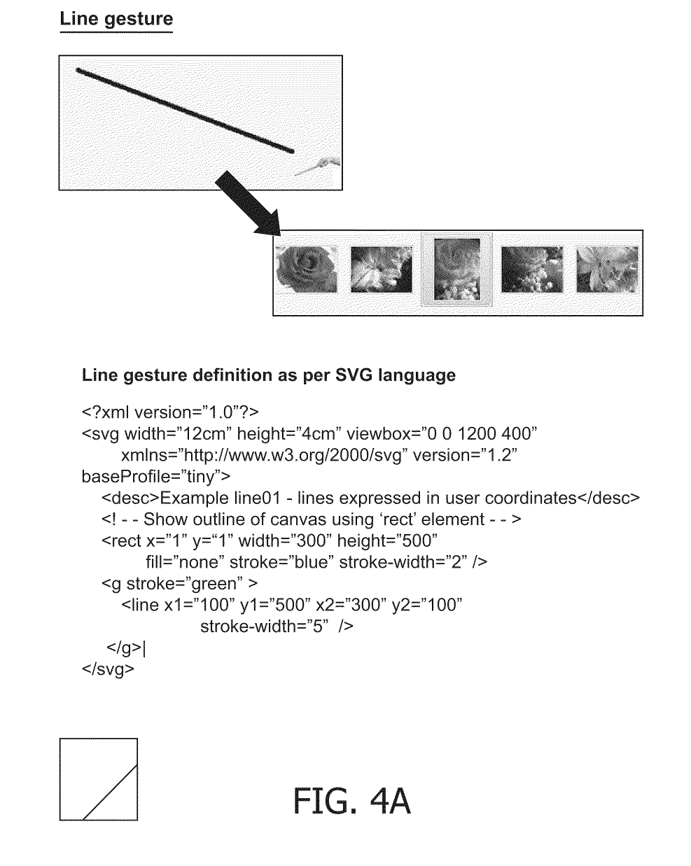

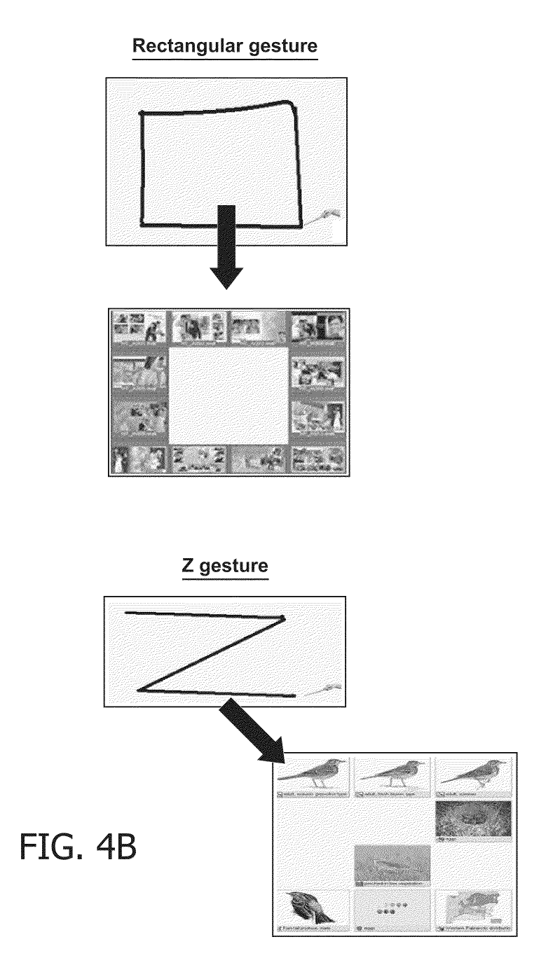

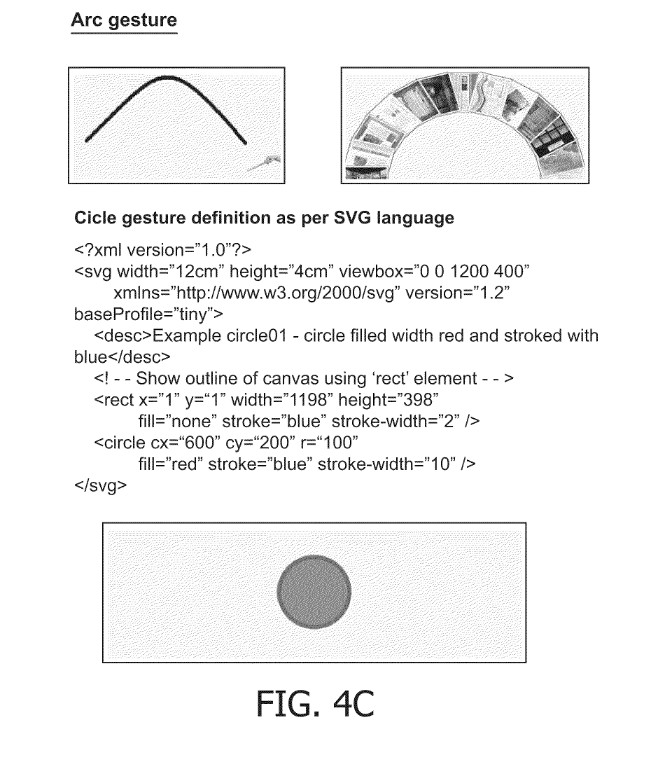

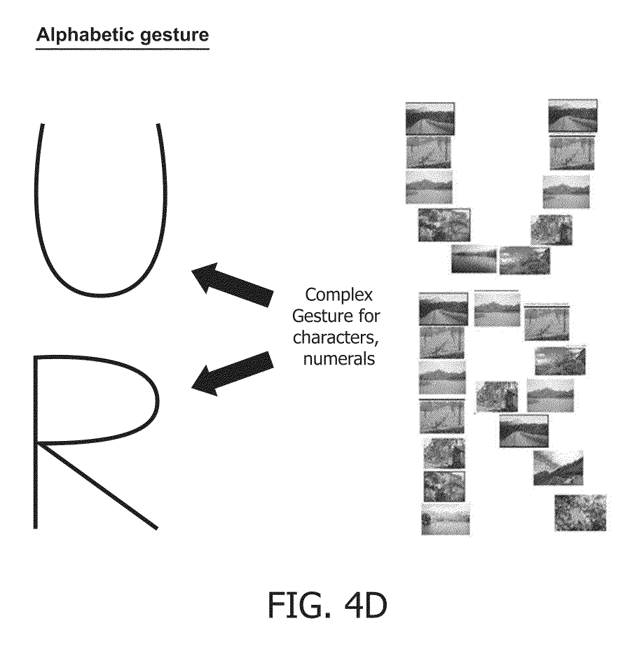

Referring now to FIG. 4A, on selection of a line gesture, the content view is generated in a linear node based on the obtained line gesture definition (e.g. the photos are arranged and presented to the user in a linear manner). Alternately, the line gesture definition itself (e.g. as per SVG language) could be selected and associated with the content. On selection of a rectangular gesture (Cf. FIG. 4B), the content view is generated in a rectangular mode based on the obtained rectangular gesture definition (e.g. the photos are arranged and presented to the user in a rectangular manner). Alternately, the rectangular gesture definition itself (e.g. as per SVG language) could be selected and associated with the content. On selection of a Z shape gesture, the content view is generated in a zig-zag mode based on the obtained Z gesture definition (e.g. the photos are arranged and presented in a zig-zag manner). Alternately, the Z gesture definition itself (e.g. as per SVG language) could be selected and associated with the content. On selection of an arc/circle gesture (Cf. FIG. 4C), the content view is generated in an arc/circular mode based on the obtained arc/circular gesture definition (e.g. the photos are arranged and presented in a circular manner). Alternately, the circle gesture definition itself (e.g. as per SVG language) could be selected and associated with the content. On selection of an alphabetic gesture (Cf. FIG. 4D), the content view is generated in an alphabetic mode based on the obtained alphabetic gesture definition (e.g. the photos are arranged and presented in the form of the alphabet U or alphabet R). On selection of a numeric gesture, the content view is generated in a numeric mode based on the obtained numeric gesture definition.

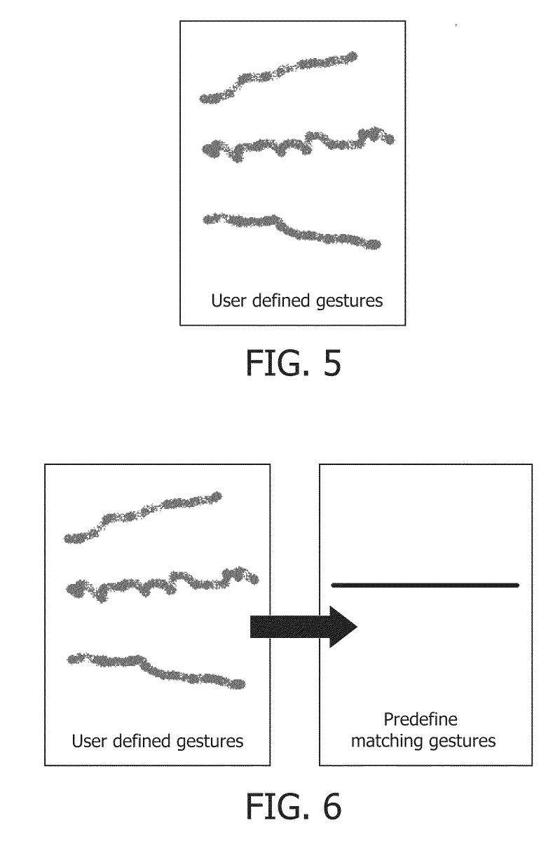

Referring now to FIG. 5, the user is allowed to create hand gestures and input the hand created gestures. The gestures intuitive to the user could be drawn. The content views could be generated based on the hand drawn gestures. This could provide flexibility to the user to generate personalized and intuitive content views. A gesture definition for the hand created gesture could be generated and used to generate content views. As an illustrative example, a gesture based on initials of a user (e.g., Character “D” for David; Character “P” for Peter) wherein the content (e.g., photos) is arranged in the manner of the character “D” or in the manner of the character “P” could be more enjoyable to the user. This could increase the user experience, the user satisfaction levels and also could enhance the Net Promoter Score (NPS). This could also provide more flexibility to the user to select the manner in which content views are to be generated. As an illustrative example, when the content views do not match the user's idea of what it should be, the user can draw new gestures and input the new gesture that is interesting to the user. This could provide enhanced user experience.

Referring now to FIG. 6, generating content views based on the hand created gesture inputs comprises

a) comparing the obtained gesture definition with the list of pre-determined gesture definitions and obtaining a closely matched gesture definition, the closely matched gesture definition corresponding to the hand created gesture;

b) generating the content views based on the closely matched gesture definition, the content views defining the arrangement and presentation of the content to the user for viewing and

c) displaying the generated content views on the display device.

Alternately, the free form gesture could be compared with the list of pre-determined gestures and a closely matched gesture and the corresponding gesture definition could be obtained.

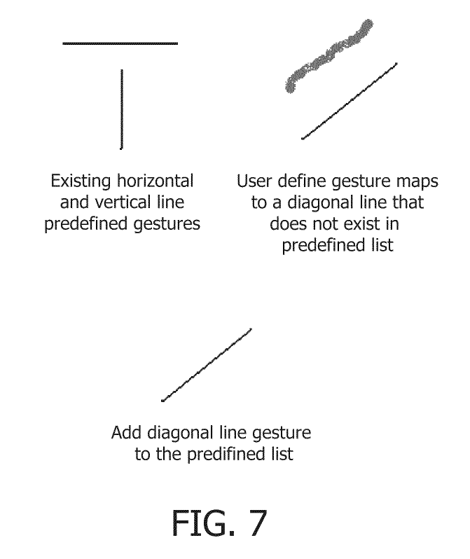

Referring now to FIG. 7, new gestures could be added/deleted from/to the pre-defined gestures (e.g. via a software upgrade or user input). This could provide more flexibility to the user to define content views of his/her choice as more and more gestures become available to the user. Further, this could also overcome the limitation of a display device that has limited pre-defined list of gestures. As an illustrative example, let us assume that the pre-defined list of gestures supported includes a horizontal line and a vertical line. The user creates a new gesture that is a diagonal line that does not exist in the pre-defined list of gestures. In such a scenario, the user can add the new diagonal line gesture to the pre-defined list of gestures providing flexibility to the user to generate new content views. This could also enhance user experience. Alternately, new gesture definitions could be added/deleted from/to the pre-defined gesture definitions.

The method further comprises
determining transition effects to be used while rendering the content on the display device; and
rendering the content views based on i) the determined transition effects and ii) the gesture definition associated with the content.

This embodiment allows personalization of content views. The transition effects could be determined based on i) the total time duration available for the content to be rendered ii) the number of steps in which the content is to be rendered.

Once the user has determined a timeline for presentation of the content and has decided to render the content, it will be easy to generate the content views using the associated transition effects. As an exemplary illustration, transition effects such as fading and wipes could be realized. Further, transition effects could be used to fade the video in and out.

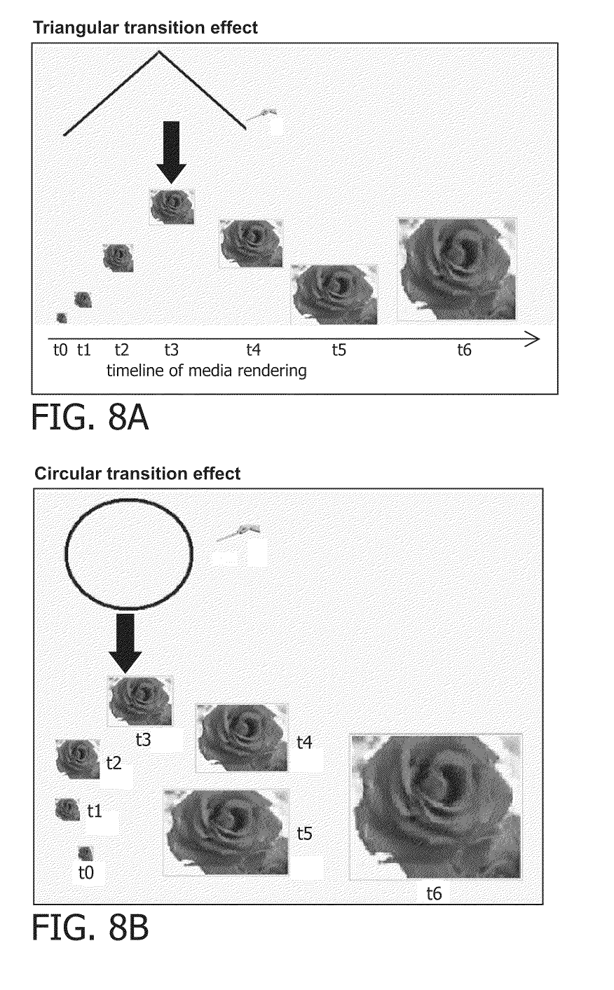

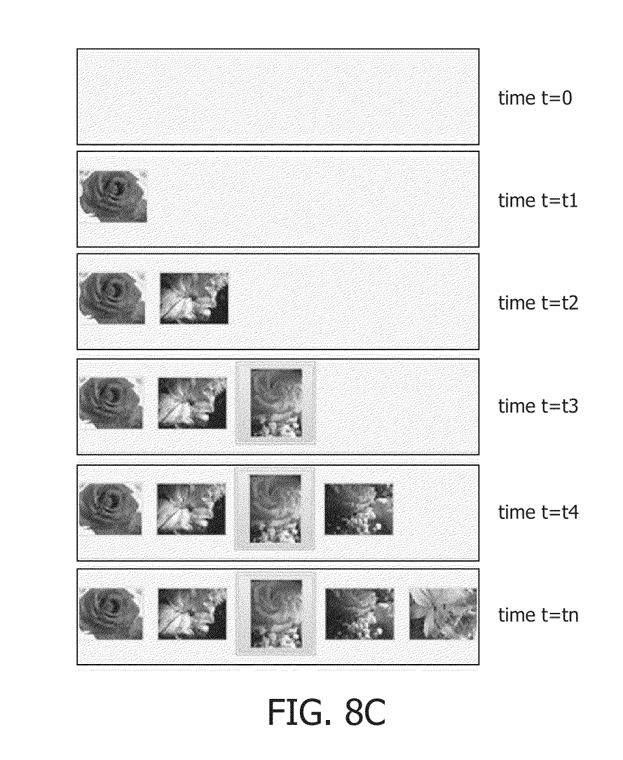

The content view of a photo of the flower is to be rendered in N steps and the total time duration is T seconds. If N=7 and T=14 seconds, then t=(T/N)=(14/7)=2 seconds. This implies that the content will have to be rendered every 2 seconds in a transition mode and at the end of 14 seconds; the total content could be displayed as shown in FIG. 8A.

This implies that the photo of the flower would be completely rendered in 14 seconds and in
t₀=2 seconds, a transition of the photo is rendered
t₁=4 seconds, a further transition of the photo is rendered
t₂=6 seconds, a still further transition of the photo is rendered
t₃=8 seconds, a still further transition of the photo is rendered
and so on . . .
and at t₆=14 seconds, the transition mode ends and the complete photo is rendered.

The applied transition effect could vary in i) size of the content ii) transparency of the content over N steps wherein every step is executed at relative time t (n) with respect to the total time duration T such that

0<t(n)<T and

t(n−1)<t(n)<t(n+1)

where t(N−1)=T and t(0)=0.

The transparency of the content could be minimum at t=0 and maximum at t=(N−1).

N and T could be user defined and also there could be a default value per gesture definition. Duration between each step could be uniform or non-uniform depending on user's choice/settings. It is also possible that other features of the content like brightness, hue, contrast could be varied over timeline to apply as transition effect while rendering the content.

Maximum and minimum transparency could be platform defined values. Further, flexibility could be given to the user to override the pre-defined transparency values. The dimensions of the content scaling while rendering the content could be platform defined values. Further, flexibility could be given to the user to override the pre-defined values.

Further, the transition effect could be applied based on the interpreted gesture. Referring now to FIGS. 8A, 8B, as an illustrative example, the photos of the flowers are arranged in a triangular manner (circular manner) based on the triangular gesture (circular gesture). Further, the photo of the flower would be rendered in a triangular mode (circular mode) using the selected transition effect.

Referring now to FIG. 8C,
at time t=0, content view according to the associated line gesture has no contents visible
at time t=t₁, content view according to the associated line gesture has one element visible
at time t=t₂ content view according to the associated line gesture has two element visible
at time t=t₃ content view according to the associated line gesture has three element visible
at time t=t₄ content view according to the associated line gesture has four element visible
at time t=t₅ content view according to the associated line gesture has five element visible

The size of the photo and other parameters such as brightness, hue, saturation while rendering the photo at t=0, t=t₁, . . . could be controlled. This could enhance user experience and provide more flexibility to the user in generating personalized content views.

The determined transition effects and the obtained gesture definition associated with the content to be viewed could be stored as settings. The stored settings could be used to generate content views. This has the advantage that the gesture definitions need not be applied on the content immediately but could be stored as settings to be applied on the content at a later point of time. This could enable the user to have more flexibility in personalizing his/her content views.

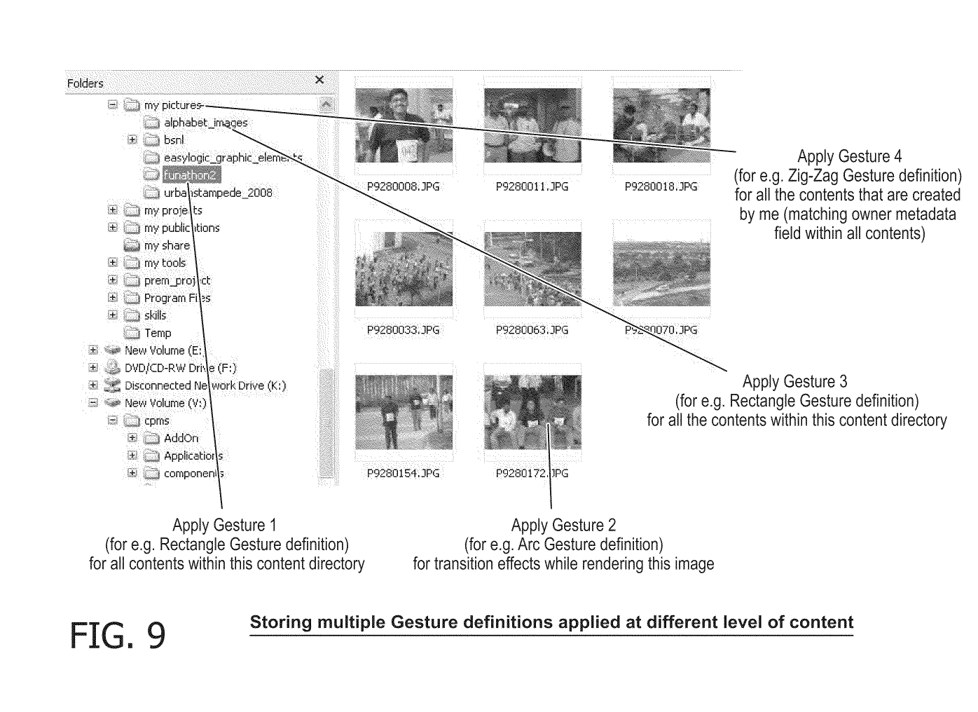

Referring now to FIG. 9, the user can relate the gesture or the gesture definition associated with the content to be viewed in at least one of the following manner:
Singular content level association
Plural content level association
Content type level association
Content viewing time level association

This allows further personalization of content views. The user can associate the gesture definition with the content in multiple ways. This association of the gesture definition with the content could be applied for generating the content view as well as transition effects associated with rendering the content.

1. Singular content level association: The gesture definition could be associated to a particular content file (e.g., an image or a video) along with the transition effect that needs to be applied on the content while rendering the content file.

2. Plural content level association: The gesture definition could be associated with a content directory along with the transition effect that needs to be applied on the content directory. In such a scenario, all the contents (and the sub-directories) within that directory could use the associated gesture for generating the content view. Further, the content could be rendered based on the applied transition effect.

3. Content type level association: The gesture definition could be associated to a particular type of content. A user for e.g., could decide to associate a line gesture for all images while use circle gesture for all videos thereby associating different gestures for different content types. This could be extended to mime-types associated with different content types. This could be relevant when content is being retrieved from Internet or via other connectivity interfaces like DLNA/UPnP. It could be possible to associate the gesture with a specific meta-data of content e.g., all files created by a user could use one gesture while all files created by user's spouse could use another gesture for generating content views and transition effects for rendering the content.

4. Content viewing time level association: The gesture definition could be associated with the content (s) for a specific data/time (e.g., associating it on a birthday or anniversary) and/or for a specific duration (e.g., next 3 hours when user is watching along with some friends/guests) and/or for specific slots within a day as per viewing pattern (e.g., in the morning to suit users favorite gesture while in the afternoon as per user wife's gesture definitions and in the evening as per users family favorite gesture).

There needs to be rules defined to prioritize the gesture definition to be applied if multiple gesture definitions are eligible for the same content by virtue of various associations made by the user. One suggested way to prioritize the gesture definition to be applied could be to follow the below mentioned rule in the decreasing order
1. Content viewing time level association (time domain is given priority)
2. Singular content level association (local selection is given priority over global selection)
3. Plural content level association (A gesture applied over content sub-directory could have a higher priority over gesture applied over parent directory)
4. Content type level association

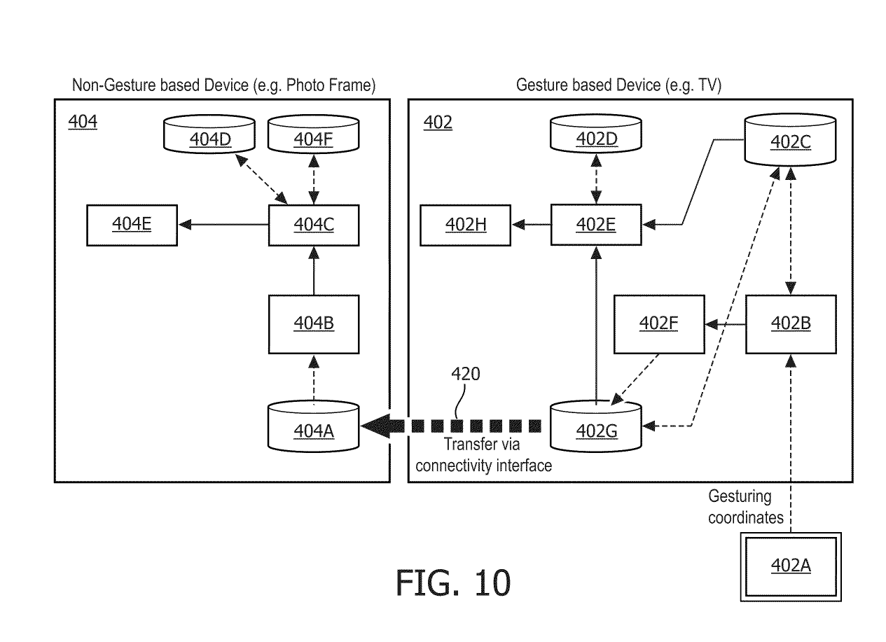

Referring now to FIG. 10, the method for displaying content on a display device further comprises
determining whether the display device on which the content views are to be generated is a non-gesture based display device and if so

a) importing gesture definitions;

b) generating the content views using i) the imported gesture definitions and ii) the received gesture definition associated with the content to be viewed; and

c) displaying the generated content views on the non-gesture based display device.

This has the advantage that the disclosed method is useful for devices that do not support gestures but still want to generate content views based on gestures. In such a scenario, the non-gesture based display device could import the gesture definitions from other devices that support gesture definition and generate personalized content views to the user. This could enhance user experience and improve the Net Promoter Score.

Further, it is noted that other devices from where gesture definitions could be imported need not be a gesture based device as long as the other device is able to provide gesture definitions.

Alternately, it is also possible that a gesture based device having limited free form gesture/gesture definitions could import gesture definitions from yet another gesture based device. This could provide more choices and flexibility to the user to select free form gestures/gesture definitions and generate personalized content views.

Referring now to FIG. 10, the gesture based display device 402 includes the following:

1. Gesture input device 402A

2. Gesture interpretation unit 402B

3. Gesture definition list 402C

4. Content 402D

5. Content view manager 402E

6. Graphical programming logic generator 402F

7. Graphical program logic 402G

8. Display unit 402H

Gesture definitions could be in the form of small logic for e.g. LOGO/SVG programming that defines different graphical shapes. As an illustrative example, the different graphical shapes are available in http://el.media.mit.edu/logo-foundation/logo/turtle.html

In order to generate the content views based on gesture inputs, the non-gesture based device 404 could:

1. support at least one connectivity interface 420 such as USB, Wi-Fi, Ethernet,Bluetooth or HDMI-CEC to import gesture definitions from another device understanding gestures

2. interpret gesture definition file in the form of graphical programming language instructions e.g. LOGO/SVG programming As an illustrative example, LOGO/SVG programming repeat 4 [forward 50 right 90] represents a square.

The non-gesture based display device (e.g. photo frame) 404 includes the following:

1. Graphical program logic 404A

2. Graphical programming logic interpreter 404B

3. Content view manager 404C

4. Content 404D

5. Gesture definition list 404F

6. Display unit 404E

The gesture based display device 402 could transfer the graphical program logic to the graphical program logic of the non-gesture based device 404 via the connectivity interface 420. Alternately, the non-gesture based device 404 could itself have an inbuilt pre-determined gesture definition list that could be made use of.

The gesture based display device 402 could provide gesture definitions to the non-gesture based device 404 and

1. support at least one connectivity interface 420 such as USB, WiFi, Ethernet, Bluetooth or HDMI-CEC to export gesture definitions to the non-gesture based device 404

2. support gestures and translate the interpreted gestures into a simple logic (e.g. in the form of graphical programming language instructions like LOGO/SVG programming; for e.g. Square gesture could be represented in LOGO programming as repeat 4 [forward 50 right 90])

Further, the content view manager 402E could use gesture definitions from:

i) pre-defined gesture definition ids from gesture definition list 402C or from

ii) graphical programming logic 402G in terms of e.g. logo program or SVG program generated from free form gestures after being interpreted by gesture interpretation unit 402B and generated by graphical programming logic generator 402F. This programming logic can be stored on the device and its id can be generated and added to the gesture definition list 402C for further use.

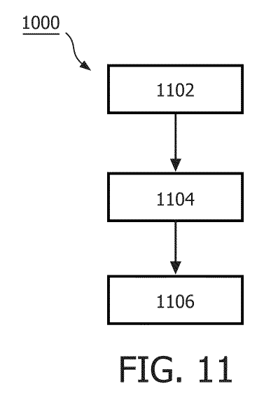

Referring now to FIG. 11, the apparatus 1000 for displaying content on a display device based on gesture input comprises:
a gesture input unit configured to receive the gesture input 1102 associated with the content to be viewed as a i) free form gesture or as a ii) gesture definition
a logical determining unit configured to determine 1104 whether the received gesture input is a free gesture and if so interpreting the received free form gesture using a gesture interpretation mechanism and obtaining a gesture definition;
a content view generating unit 1106 configured
to generate content views based on the gesture definition, the content views defining the arrangement and presentation of the content to a user for viewing; and
to display the generated content views on the display device.

The disclosed invention has the following differences and/or advantages over the prior art US2008/0168403:

1. The method disclosed in the present invention uses gesture for performing certain actions/operations on the content that is yet to be displayed and then displays the content incorporating the performed actions/operations. The prior art method does not disclose this aspect.

2. The method disclosed in the present invention extends the scope of the interpreted gestures to be used as a generic setting. The generic settings could be applied on all screens based on various configurable parameters such as specific user/content type and or time. The prior art does not disclose this aspect.

3. The method disclosed in the present invention uses gestures to define transition effects or animations (e.g. that can be applied when slideshow of photo is performed). The prior art method limits itself on initiating movements or scrolling based on gesture inputs.

4. The method disclosed in the present invention is also useful for non-gesture based devices (that do not support gestures) to generate customized content views based on gesture inputs. The prior art method does not disclose this aspect.

5. The method disclosed in the present invention makes use of gesture for generating personalized content views whereas in the prior art the gestures are used for identification purpose and for granting/denying access.

6. The method disclosed in the present invention does not propose techniques for gesture interpretation but uses the prior art techniques. On the other hand, the prior art method discloses gesture interpretation technique based on the images generated from hand on touch panel.

The disclosed method could be used in all applications wherein the user needs to view data and navigate/browse through the views for e.g. channel list and EPG data.

The disclosed method could be applied to all devices dealing with content management such as televisions, set-top boxes, Blu-ray players, hand held devices and mobile phones supported with gesturing input device such as 2-D touchpad or pointer device.

The disclosed method could also be used for photo frame devices enabling viewing of photos in a personalized way.

The disclosed method is also applicable to personal computers for desktop management and thumbnail views management.

In summary, a method for displaying content on a display device based on gesture input is disclosed. The method comprises:
receiving the gesture input 102 associated with the content to be viewed as a i) free form gesture or as a ii) gesture definition
determining whether the received gesture input is a free form gesture and if so interpreting the received gesture 104 using a gesture interpretation mechanism and obtaining a gesture definition;
generating content views 106 based on the gesture definition, the content views defining the arrangement and presentation of the content to a user for viewing; and
displaying 108 the generated content views on the display device.

Although claims have been formulated in this application to particular combinations of features, it should be understood that the scope of the disclosure of the present invention also includes any novel features or any novel combination of features disclosed herein explicitly or implicitly or any generalization thereof, whether or not it relates to the same subject matter as presently claimed in any claim and whether or not it mitigates any or all of the same technical problems as does the present invention.

While the invention has been illustrated in detail in the drawings and foregoing description, such illustration and description are to be considered illustrative or exemplary and not restrictive; the invention is not limited to the disclosed embodiments. Other variations to the disclosed embodiments can be understood and effected by those skilled in the art of practicing the claimed subject matter, from a study of the drawings, the disclosure and the appended claims. Use of the verb “comprise” and its conjugates does not exclude the presence of elements other than those stated in a claim or in the description. Use of the indefinite article “a” or “an” preceding an element or step does not exclude the presence of a plurality of such elements or steps. A single unit may fulfill the functions of several items recited in the claims. The mere fact that certain measures are recited in mutually different dependant claims does not indicate that a combination of these measures cannot be used to advantage. The figures and description are to be regarded as illustrative only and do not limit the invention. Any reference sign in the claims should not be considered as limiting the scope.

1. A method (100) for displaying content on a display device based on gesture input, the method comprising:
receiving the gesture input (102) associated with the content to be viewed as a i) free form gesture or as a ii) gesture definition
determining whether the received gesture input is a free form gesture and if so interpreting the received gesture (104) using a gesture interpretation mechanism and obtaining a gesture definition;
generating content views (106) based on the gesture definition, the content views defining the arrangement and presentation of the content to a user for viewing; and
displaying (108) the generated content views on the display device.

2. The method as claimed in claim 1, wherein the method comprises
selecting the gesture input from a list of pre-determined gestures; and
associating the selected gesture with the content to be viewed.

3. The method as claimed in claim 1, wherein the method comprises
selecting the gesture definition from a list of pre-determined gesture definitions; and
associating the selected gesture definition with the content to be viewed.

4. The method as claimed in claim 2, wherein the gesture input associated with the content to be viewed is in the form of at least one of:
a line and the content view is generated in a linear mode based on the obtained line gesture definition
a rectangle and the content view is generated in a rectangular mode based on the obtained rectangular gesture definition
a Z shape and the content view is generated in a zig-zag mode based on the obtained Z gesture definition
an arc or circle and the content view is generated in an arc/circular mode based on the obtained arc/circular gesture definition
an alphabet and the content view is generated in an alphabetic mode based on the obtained alphabetic gesture definition
a numeral and the content view is generated in a numeric mode based on the obtained numeric gesture definition.

5. The method as claimed in claim 3, wherein the gesture definition associated with the content to be viewed is in the form of at least one of:
a line and the content view is generated in a linear mode based on the selected line gesture definition
a rectangle and the content view is generated in a rectangular mode based on the selected rectangular gesture definition
a Z shape and the content view is generated in a zig-zag mode based on the selected Z gesture definition
an arc or circle and the content view is generated in an arc/circular mode based on the selected arc/circular gesture definition
an alphabet and the content view is generated in an alphabetic mode based on the selected alphabetic gesture definition
a numeral and the content view is generated in a numeric mode based on the selected numeric gesture definition.

6. The method as claimed in claim 1, wherein the method further comprises
creating hand gesture; and
associating the hand created gesture with the content to be viewed.

7. The method as claimed in claim 6, wherein the method further comprises
comparing the obtained gesture definition with the list of pre-determined gesture definitions and obtaining a closely matched gesture definition, the closely matched gesture definition corresponding to the hand created gesture;
generating the content views based on the closely matched gesture definition, the content views defining the arrangement and presentation of the content to the user for viewing; and
displaying the generated content views on the display device.

8. The method as claimed in claim 2, wherein the method further comprises
adding/deleting gestures from/to the list of pre-determined gestures

9. The method as claimed in claim 3, wherein the method further comprises
adding/deleting gesture definitions from/to the list of pre-determined gesture definitions

10. The method as claimed in any one of the claims 1-9, wherein the method further comprises
determining transition effects to be used while rendering the content on the display device; and
rendering the content views based on i) the determined transition effects and ii) the gesture definition associated with the content.

11. The method as claimed in claim 10, wherein the method further comprises
storing the determined transition effects and the gesture definition associated with the content to be viewed as settings; and
using the stored settings to generate the content views.

12. The method as claimed in any one of the claims 1-11, wherein the user relates the free form gesture or the gesture definition associated with the content to be viewed in at least one of the following manner:
Singular content level association
Plural content level association
Content type level association
Content viewing time level association

13. The method as claimed in claim 1, wherein the method further comprises
determining whether the display device on which the content views are to be generated is a non-gesture based display device and if so
a) importing gesture definitions;
b) generating the content views using i) the imported gesture definitions and ii) the received gesture definition associated with the content to be viewed; and
c) displaying the generated content views on the non-gesture based display device.

14. An apparatus (1000) for displaying content on a display device based on gesture input, the apparatus comprising:
a gesture input unit configured to receive the gesture input (1102) associated with the content to be viewed as a i) free form gesture or as a ii) gesture definition
a logic determining unit configured to determine (1104) whether the received gesture input is a free gesture and if so interpreting the received free form gesture using a gesture interpretation mechanism and obtaining a gesture definition;
a content view generating unit (1106) configured
to generate content views based on the gesture definition, the content views defining the arrangement and presentation of the content to a user for viewing; and
to display the generated content views on the display device.

15. A software program comprising executable codes to carry out the method in accordance with any of claims 1 to 13.
